(19) United States
(12) Patent Application Publication
(10) Pub. No.: US 2007/0254680 A1
(43) Pub. Date: Nov. 1, 2007

(54) Wirefree intercom having low power system and process

(76) Inventor: Shary Nassimi, Malibu, CA (US)

Correspondence Address: BOND, SCHOENECK & KING, PLLC, ONE LINCOLN CENTER, SYRACUSE, NY, 13202-1355, US

(21) Appl. No.: 11/380,994

(22) Filed: May 1, 2006

(51) Int. Cl. H04Q 7/20

(52) U.S. Cl. 455/462

(57) ABSTRACT

A wireless intercom having a microcontroller that is programmed to place the intercom into a power saving sleep mode unless actively receiving or transmitting signals. The microcontroller of the intercom is interconnected to a transceiver for sending and receiving digital data packets, and to a code for converting the digital packets to analog sound signals, and vice versa. The intercom awakens periodically to determine whether any appropriate transmissions have been received. Unless the signals detected by the intercom include the appropriate identification, the intercom is placed back into sleep mode.

### BACKGROUND OF THE INVENTION

1. Field of Invention

The present invention relates to intercom systems and, more specifically, to a wirefree intercom having low power usage.

2. Description of Prior Art

Conventional intercoms are powered by the wall outlet and transmit the voice of the speaker over the wires installed throughout the home. These intercoms use power line modulation techniques and have limited ranges due to the need for physical attachment to the power lines in the wall, as well as when the possibility of phase changes in the power connection that may interfere with the signal. In addition, the sound quality is often limited in such systems, and when there is a motor (such a hair dryer or vacuum cleaner) also in operation on the circuit, the signal is often distorted or destroyed.

Wireless intercoms use a radio signal and, like conventional intercoms, are powered by a wall outlet. These devices usually employ Family Radio Service (FRS) radio technology and have decent range capabilities. However, such devices do not provide security when multiple devices are employed in a dwelling. For example, if there are five units in a home and all are set to the same security number, each unit allows for reception of a conversation occurring between any other two units. In a business environment, this loss of security is not desirable. Additionally, such devices consume too much power and are thus not feasibly implemented without a direct power connection to a wall outlet. Some wireless intercoms use both wall power and batteries. In addition to limitation described above with respect to wireless intercoms, the batteries in such systems will only last about a day or two when the device is left on.

### SUMMARY OF THE INVENTION

It is a principal object and advantage of the present invention to provide a wirefree intercom system that avoids the need for line power.

It is another object and advantage of the present invention to provide a wirefree intercom system that has low power consumption.

It is an additional object and advantage of the present invention to provide a wirefree intercom system having an unlimited number of units.

It is a further object and advantage of the present invention to provide a wirefree intercom system that provides secure conversation.

It is another object and advantage of the present invention to provide a wirefree intercom that is not affected by line noise.

It is an additional object and advantage of the present invention to provide a wirefree intercom system that has a long range.

It is a further object and advantage of the present invention to provide a wirefree intercom system that has clear sound qualities.

Other objects and advantages of the present invention will in part be obvious, and in part appear hereinafter.

In accordance with the foregoing objects and advantages, the present invention comprises wirefree intercom having circuitry and control processing that significantly reduces power consumption. More particularly, the intercom comprises a base unit and an antenna attached thereto for communicating with any number of other based units. Each base unit comprises a microcontroller, transceiver, codec, and speaker for receiving digital signal packets and converting into audible sounds and a microphone associated with the codec, microcontroller, and transceiver for converting sounds into digital data packets and transmitting to a remote intercom. The power reduction circuitry comprises the use of a wake timer and a talk timer that limit the amount of time that the associated circuitry remains operative. More particularly, the wake timer places the microcontroller in a timed, periodic sleep mode. After the expiration of the wake timer, the microcontroller activates the transceiver and checks for the presence of appropriate digital signals. If no signals are received, the intercom returns to sleep mode, thereby reducing power consumption.

### BRIEF DESCRIPTION OF THE DRAWINGS

The present invention will be more fully understood and appreciated by reading the following Detailed Description in conjunction with the accompanying drawings, in which:

FIG. 1A is a perspective view of a wirefree intercom base unit according to the present invention.

FIG. 1B is a perspective view of a wirefree intercom base unit according to the present invention.

FIG. 2 is a schematic of circuitry for a wirefree intercom base unit according to the present invention.

FIG. 3 is a flowchart of a control process for a wirefree intercom base unit according to the present invention.

FIG. 4 is a continuation of the flowchart of FIG. 3 of a control process for a wirefree intercom base unit according to the present invention.

FIG. 5 is a flowchart of a pairing process for a wirefree intercom base unit according to the present invention.

FIG. 6 is a flowchart of a security process for a wirefree intercom base unit according to the present invention.

FIG. 7 is a flowchart of a power conservation process for a wirefree intercom base unit according to the present invention.

FIGS. 8A and 8B are schematics of interference in a dual channel system according to the present invention.

FIG. 9 is flowchart of a digital signal restoration process for a wirefree intercom base unit according to the present invention.

### DETAILED DESCRIPTION

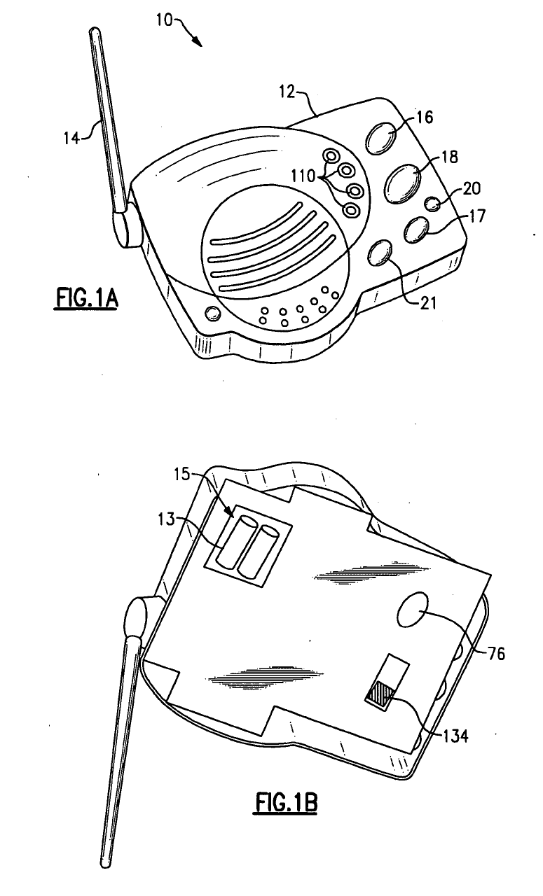

Referring now to the drawings, wherein like numerals refer to like parts throughout, there is seen in FIGS. 1A and 1B a wirefree intercom 10 according to the present invention. Intercom 10 comprises a base unit 12 and an antenna 14 attached thereto. Base unit 12 houses the circuitry for providing wireless intercom capabilities, without the need for line power or excessive battery power usage, as will be described hereinafter. Base unit 12 further houses a power source, such as a conventional battery 13, which may be received in a compartment 15 formed into the bottom of base unit 12. Base unit 12 may further include a channel select button 16, which allows a user to cycle through the preselected channels or select all of the preselected channels for transmission and reception. Intercom 10 may further comprise any number of illuminating regions 17, such as LEDs, for reflecting the current operating mode of base unit 12, such as “sleep” or active, for indicating whether the power “on,” etc. Intercom 10 further comprises a talk button 18 for transmitting from intercom 10, a microphone 20 for receiving sounds to be transmitted, and a volume button 21 to control the volume of sounds played back on intercom 10.

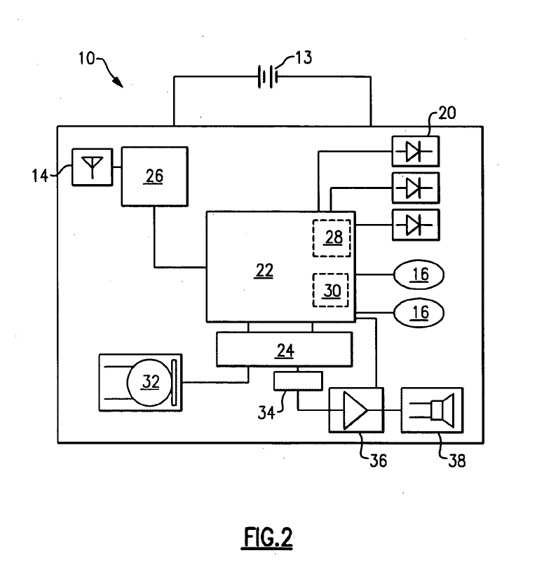

Referring to FIG. 2, base unit 12 comprises a microcontroller 22 interconnected to a codec 24 for converting analog signals to digital signals (and vice versa) and interconnected to a digital radio transceiver 26 for transmitting and receiving digital signals. Microcontroller 22 is selected to be able to perform radio base-band functions, carry out compression and de-compression of digitized data, assemble digital data transmission signals, and disassemble received digital data signals. As will be explained in detail hereinafter, microcontroller 22 further includes a wake timer 28 and a talk timer 30 for controlling whether and when base unit 12 is in “sleep” mode, thereby conserving energy, or a “wake” mode, where microcontroller 22 periodically “sniffs” for incoming signals. It should be recognized that wake timer 28 and talk timer 30 may be implemented in separate hardware devices or by programming wake timer 28 and a talk timer 30 into microcontroller 22. Preferably, wake timer 28 of microcontroller 22 (and any other timers) comprises a watchdog style timer that may be operated while microcontroller 22 has otherwise been deactivated. Microcontroller 22 may comprise a low-power CMOS 8-bit microcontroller based on the AVR enhanced RISC architecture, such as an ATMEL Mega 88 available from the Atmel Corporation of San Jose, Calif.

Transceiver 26 is a conventional 915 MHz, multi-spectrum transceiver that is further associated with antenna 14 for transmitting and receiving digital radio signals. Transceiver 26 preferably supports about 125 radio channels, which may be chosen automatically or at the request of microcontroller 22, and wherein each channel allows for communications without interfering with other channels. Transceiver 26 should be capable of reliably transmitting to and from another intercom 10 at distances of up to 1000 feet. Transceiver 26 may comprise a low power, low-IF transceiver designed for operation in the license-free ISM bands at 433 MHz, 868 MHz and 915 MHz, such as an ADF 7020 available from Analog Devices, Inc. of Norwood, Mass.

Codec 24 is a conventional encoder-decoder for converting analog signals to digital code, and vice versa. Codec 24 may further compress the signals to conserve bandwidth. Codec 24 may comprise an ultra low-power codec including a microphone supply, preamplifier, 16-bit ADC, 16-bit DAC, serial audio interface, as well as power management and clock management for the ADC and the DAC. The sampling frequency of the ADC and of the DAC is preferably adjustable 4 kHz to 48 kHz. For example, codec 24 may comprise an XE3005 available from Semtech Corporation of Camarillo, Calif.

The analog to digital input portion of codec 24 is interconnected to a microphone 32 for receiving voice signals and creating electrical analog voice signals from captured sounds. Codec 24 encodes the analog voice signals into digital packets and provides the encoded digital packets to microcontroller 22. Microcontroller 22 buffers the digitized sound packets and applies compression algorithms, such as Adaptive Differential Pulse Code Modulation (ADPCM) or Delta Modulation, if desired, to reduce the packet size. An identification tag is also added to the packets, and they are sent by microcontroller to transceiver 26 for transmission to another base unit 12.

The digital to analog portion of codec 24 is interconnected to a filter 34 for conditioning outgoing analog signals and reducing noise. Filter 34 may comprise an operational amplifier and conventional low pass, high pass, or band pass filter.

Filter 34 is further interconnected to an amplifier 36 for improving the quality of signals in the sound spectrum at the lowest possible power consumption. Microcontroller 22 may be interconnected directly to amplifier 38 for supplying control signals that control the power consumption of amplifier 38. Amplifier 38 may comprise a conventional, off-the-shelf amplifier.

Amplifier 38 is connected to a speaker 40 for outputting audible sounds based on the amplified sound signals converted by codec 24 and processed by filter 36.

Packets of data containing digitized voice signals, as well as an appropriate ID information data string, that are received by transceiver of base unit 12 are transferred from transceiver 26 to microcontroller 22 for playback. Microcontroller 22 decompresses the data (if necessary) and sends the signals to codec 24. Codec 24 then converts the digital signals to analog sound signals, which are filtered by filter 34, amplified by amplifier 36, and output by speaker 38.

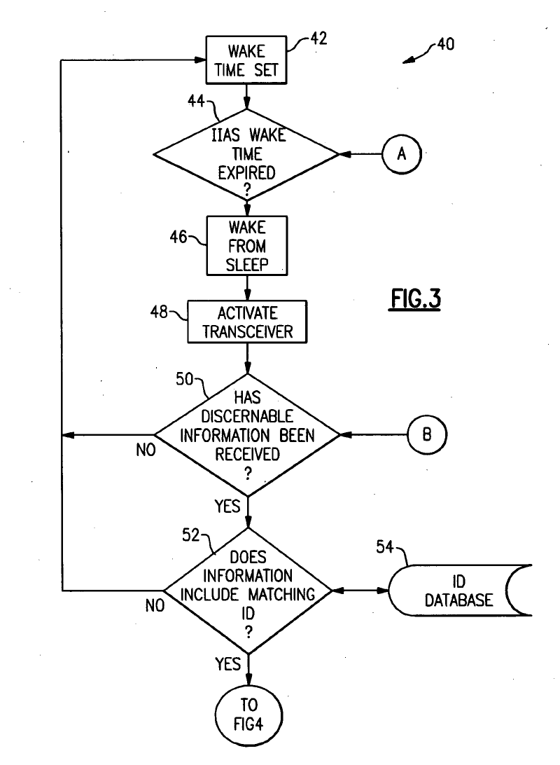

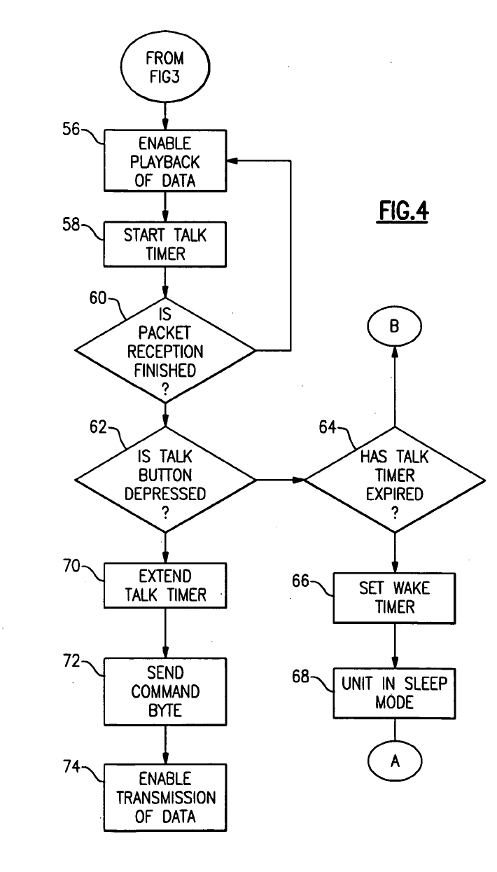

The present invention reduces power consumption by engaging in a nearly complete shutdown of all circuitry for a predetermined period of time, which may be variable, depending on usage of intercom 10. Referring to FIG. 3, the basic power-saving “sniff” process 40 of the present invention commences with the setting 42 of wake timer 28, thereby placing intercom 10 in sleep mode. As a result, power consumption for unit 12 is reduced to the microamp range. When wake timer 28 expires 44, microcontroller 22 awakes from sleep mode 46, and “sniffs” for a signal by activating transceiver 26 for the receipt of signals 48. A check is then performed 50 to determine whether any information received by transceiver 26 is discernable. If so, the incoming ID byte is checked 52 against a reference database 54 to determine whether it matches a stored ID. If not, base unit 12 goes back to sleep at step 42, thereby conserving energy. If the ID matches, then microcontroller 22 awakens codec 24, and enters full function mode, as illustrated in FIG. 4.

Referring to FIG. 4, if an ID is matched at step 52, playback of data is enabled 56. More specifically, codec 24 is enabled thereby starting packet reception, packet decompression, and error correction. Talk timer 30 is started 58, and a check is performed 60 to determine whether packet reception has finished. If not, control returns to step 56. If packet reception has finished at step 60, a check is performed to determine whether talk button 18 has been depressed 62. If talk button 18 has not been depressed, talk timer 30 is checked 64. If talk timer 30 has expired, wake timer 28 is set 66 and intercom 10 is sent into sleep mode 68. If talk timer 30 has not expired, control returns to step 50. If the talk button was depressed at step 62, talk timer 30 is extended 70 and a command byte is sent out 72 by transceiver 26 (to another intercom 10) to reverse the direction of communication. Transmission of data by intercom 10 is then enabled 74. More particularly, microcontroller 22 switches transceiver 26 from receive mode to send mode, sound is collected by microphone 32, and the resulting analog signals are converted by codec 24 into packet data. Microcontroller 22 compresses the packets, if desired, adds the appropriate ID, and assembles the data stream for transmission by transceiver 26 to another intercom 10.

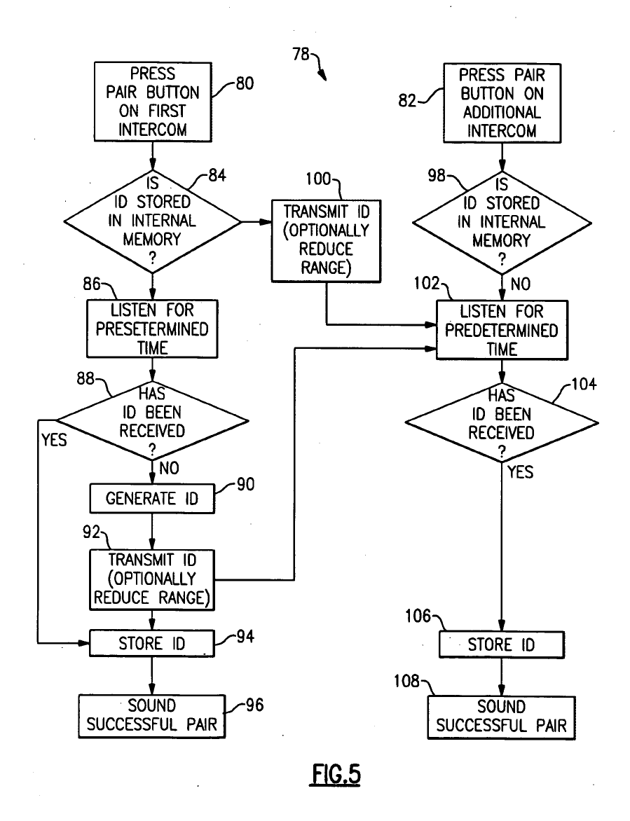

Intercom 10 may further be provided with a “pair” button 76 for commencing a pairing process 78 by which two or more intercoms 10 are configured for transmission therebetween. Referring to FIG. 5, pairing of a first intercom 10 with a second intercom 10 (or any number of additional intercoms 10) may be accomplished through pairing process 78 programmed into each intercom 10. When a user wishes to pair two or more intercoms, the user presses 80 pair button 78 of first intercom 10. The user then depresses 82 pair button 78 of any additional intercoms 10. When pair button 78 is pressed, first intercom 10 checks internal memory 84 to determine whether an ID has been previously stored. If no ID has been previously stored 84, receiver 26 of first intercom 10 listens for a predetermined period of time 86, such as one second, and checks 88 to determine whether an ID has been received (from another intercom 10). If no ID is received from another intercom 10 at step 88, first intercom generates a random ID 90 and begins transmitting the ID 92 for a predetermined amount of time. Intercom 10 may optionally decrease its RF output level by 30 dbm, so that the “teach” range is reduced to the immediate area. Intercom 10 then stored the ID 94 and sounds a successful pair 96. If an ID has been sent by another intercom 10 and received at step 88, first intercom 10 stores the ID in non-volatile memory 94 and generates a success tone from speaker 96. After depressing pair button 76 of second intercom 10 at step 84, second intercom cycles through the same process 78 as first intercom, and checks whether an ID is stored in memory 98. If first intercom 10 has an ID stored in memory at step 84 and second intercom 10 does not, the ID of first intercom 10 is transmitted 100 to second intercom 10, which will be listening for a predetermined time 102. If first intercom 10 did not have an ID stored at step 84, any stored ID in second intercom 10 will be transmitted to first intercom 10 and received at step 88. If neither first nor second intercom 10 has an ID stored, the ID that is generated by first intercom 10 at step 90 and transmitted at step 92 will be received by second intercom 10 at step 102, checked by second intercom 10 at step, stored in memory 106, and a successful pair will be sounded 108.

The present invention further provides for multiple, secure conversations occurring simultaneously on intercom 10. As explained above, transceiver 26 supports multiple channels e.g., 125 channels. Preferably, a limited number, such as four, are dedicated for transmissions on intercom 10, which may be indicated by a series of LEDS 110 on intercom 10. Intercom 10 may further be configured to allow a user to select the specific channel to be used at all times, and may additionally be configured so that a user may choose to receive transmissions on “all channels” so that intercom 10 will receive and playback transmissions on any of the designated channels. Visual indication of the status may be reflected by cycling through four LEDs 110 as button 16 is depressed, to indicate transmissions on each of four particular channels for example, or lighting all LEDs when all channels have been selected. When a call is transmitted from an originating intercom 10, the sound is played back on all intercoms 10 set to receive the designated channel (or set to receive “all channels”) and which have previously been “paired” to the originating intercom, i.e., the stored ID in all receiving intercoms 10 matches the ID of originating intercom 10.

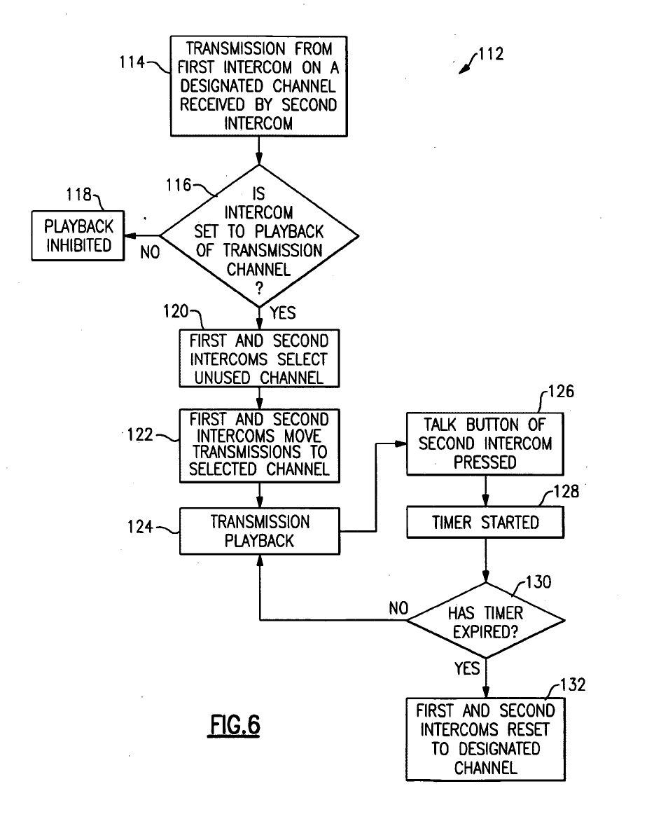

Referring to FIG. 6, a security protocol process 112 for engaging in secure transmissions may begin when a transmission on a designated channel from a first intercom 10 is initially received 114 by a second intercom 10 (or any additional intercoms 10). The second intercom then checks 116 to determine whether it is set to playback the channel of the first intercom 10. If not, playback is inhibited 118. If the channel is confirmed at step 116, first and second intercoms select one of the non-designated channels 120 of transceiver 26. For example, first and second intercoms 10 may using the last three digits of the ID of first and second intercoms 10 to select one or more of the unused 125 channels. Selection of multiple channels allows first and second intercoms 10 to have a back-up channel in case of interference on the initially selected channel. Alternatively, first and second intercoms 10 may use other means to select an unused channel or channels, such as a random channel selection. Selection 120 concludes with first and second intercoms 10 exchanging the channel or channel set, and first and second intercoms 10 then move transmission to the selected channel or channels 122. The transmission may then be played back 124 on second intercom 10. A user of second intercom 10 may then depress talk button 18 to respond the initial transmission 126. A timer may started 128 (and reset) each time the user of second intercom 10 depresses talk button 18, and then checked for expiration 130 so that first and second intercoms are reset to the designated, non-secure channel or channels 132, as soon as transmissions conclude. Security process 112 allow other intercoms 10 to freely communicate on the designated channels without interfering with communications ongoing between first and second intercoms 10 on the secure channel or channels. Security process 112 may be provided as a default setting, and first and second intercoms 10 may be provided with a bypass switch 134 that allows a user to bypass security process 112 and remain in non-secure mode so that any other “paired” intercom 10 may playback the conversation. As two or more communicating intercoms 10 also provide the IDs created during pairing process 78 when they communicate, it is also possible that multiple set of intercoms 10, each set having a different ID, may communicate securely on a given channel with respect to any intercom 10 not programmed to playback communications including that ID even if set to receive signal on the given channel.

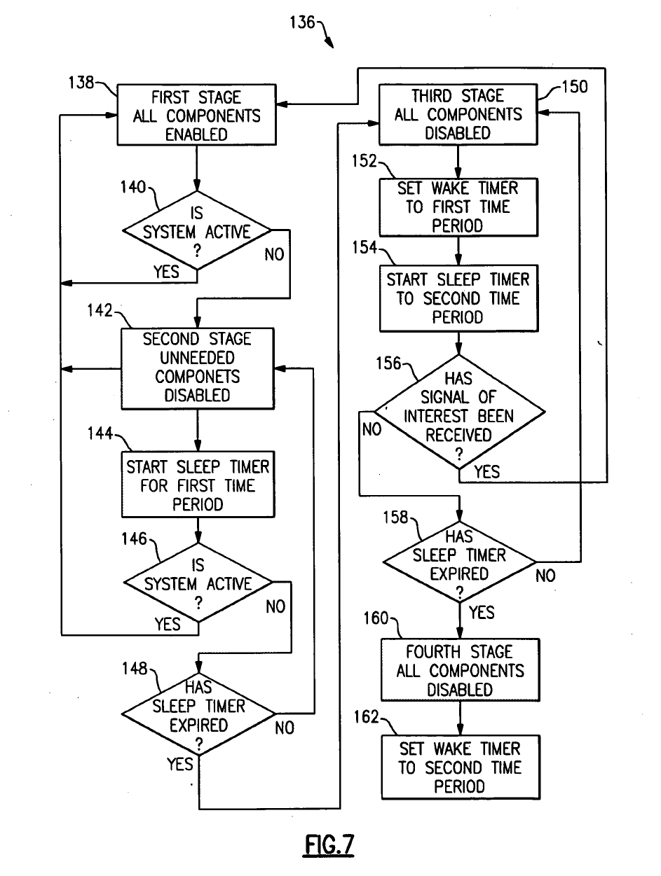

Referring to FIG. 7, microcontroller 22 may implement a multi-stage, power-saving sleep mode process 136, thereby substantially reducing power demand. In a first stage 138, intercom 10 is actively engaged in a connection, i.e., all components are enabled, intercom 10 is connected to another intercom 10, or intercom 10 is actively transmitting and receiving signals. A check is performed periodically 140 to verify that intercom 10 is active. If intercom 10 is inactive, intercom 10 is placed into a second, partial sleep stage where all unneeded components are disabled 142. For example, amplifier 36 and LEDs 110 may be powered down to conserve energy. However, transceiver 26 is kept on to verify whether other intercoms have also terminated the connection. In addition, a sleep timer is started to measure a first sleep period 144 that controls how long intercom 10 is in stage two 142. For example, sleep timer may be set for one hour. A check is then performed 146 to determine whether there is any system activity. If so, control returns to step 138. If no activity is detected, the sleep timer is checked for expiration 148. If the sleep timer has expired, intercom 10 enters a third sleep stage 150 where power is turned off to all components and wake timer 28 is set to measure a second time period 152. Wake timer 28 is preferably set for 500 milliseconds. The sleep timer is also started 154 to measure a second sleep period. Power saving process 136 then follows the basic “sniff” process, as illustrated in FIG. 3, every 500 milliseconds, i.e., a check is performed 156 to determine whether a signal of interest has been received. If no signal are detected at step 156, sleep timer is checked 158 to determine whether intercom 10 has been in third stage 150 for more than a predetermined time, such as four hours. If so, intercom 10 enters a final sleep stage 160, where all components are turned off and wake timer 28 is set 162 for a longer period of time that at step 152, such as two seconds. As illustrated in FIG. 3, microcontroller 22 executes the “sniff” process of FIG. 3 every two seconds, thereby further reducing power consumption while intercom 10 is in third stage 150. It should be recognized that multi-stage, power-saving sleep mode process 136 may be implemented in any digital transmitting and receiving device having a transceiver and microcontroller where reduced power consumption is advantageous. For example, process 136 could be implemented in a wireless security access system and even a wireless headset for a cellular or conventional telephone.

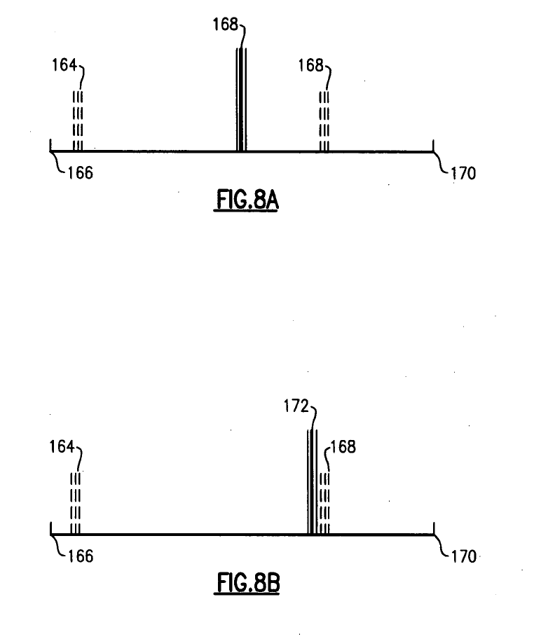

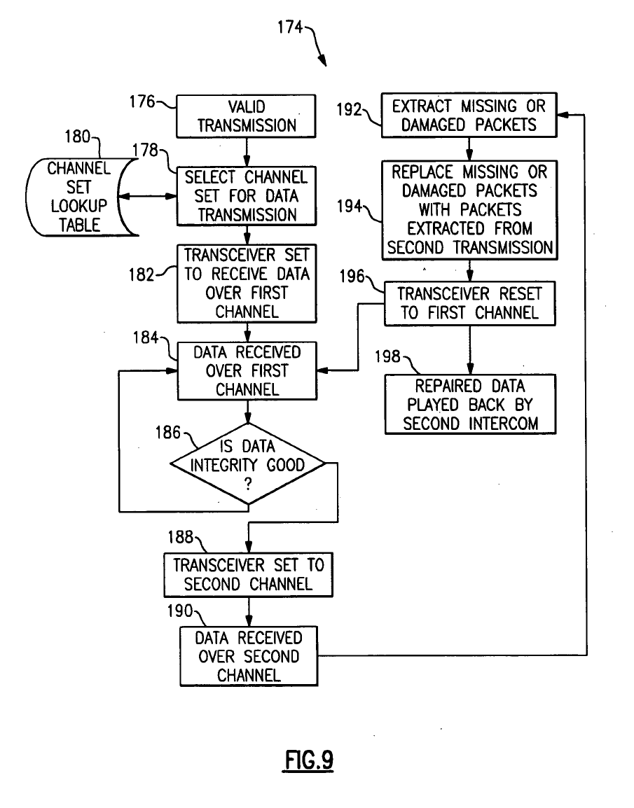

Microcontroller 22 may be programmed to improve the quality of analog playback from digitally transmitted signals. Interference may be reduced or eliminated by transmitting data transmitting data over a first channel and then immediately transmitting the data over a second, different channel, regardless of whether the receiving intercom request missing data. The second transmission may be used to repair or reconstruct any data lost or damaged in the first transmission. The first and second channels should be selected to reduce the likelihood that any interference in the transmission band of transceiver 26 will affect both channels. As seen in FIG. 8A, first channel 164 is selected to be above the minimum frequency 166 of transceiver 26, and a predetermined distance from second channel 168, which is less than the maximum frequency 170 of transceiver 26. In FIG. 8A, interference 172 is not affecting transmissions on either first channel 164 or second channel 166. In FIG. 8B, interference 172 is on or near second channel 166. First channel 164 is free from interference 172. Accordingly, any lost data in digital transmissions over second channel 166 could be repaired by the transmissions occurring over on first channel 164.

Microcontroller 22 may thus implement a sound quality improvement process 174 for increasing the clarity of transmissions between two or more paired intercoms 10. Transmission improvement process 174 commences with a valid transmission between two intercoms 176. Intercoms 10 then select the two channels for data transmission 178 (and the channel selection results are shared between intercoms 10). The first and second channels may chosen in advance by microcontroller 22 using a lookup table 180 containing a list of pairs of channel numbers. Microcontroller 22 may automatically select the channel pair, or the channel pairs may be factory installed and selected by a dipswitch. Automatic selection of the channel pair can be achieved by generating a random number in microcontroller 22 and then using the number to select the channel pair from look-up table 166. Alternatively, the channel pair could be selected by using the security ID generated or stored by intercom 10 to select a channel set. Table 1 below contains a list of 10 sets of channel pairs that may be selected by microcontroller 22 in the 902-937 Mhz band, with 3 Mhz channel spacing.

TABLE 1

| Channel Set No. | 1^{st} channel | 2^{nd} channel |
|---|---|---|
| 1 | 902 | 910 |
| 2 | 905 | 913 |
| 3 | 908 | 916 |
| 4 | 911 | 919 |
| 5 | 914 | 922 |
| 6 | 917 | 925 |
| 7 | 920 | 928 |
| 8 | 923 | 931 |
| 9 | 926 | 934 |
| 10 | 929 | 937 |

Once the channels are selected and shared 178, transceivers 26 of intercoms 10 are set to transmit and receive on the designated channel set. When data is received over the first channel 184, microcontroller 22 checks the data integrity 186. If data is good at step 186, more data may be received at step 184. If the data is damaged, transceiver 26 is set to the second channel 188 so that intercom 10 may receive the redundant transmission of data sent over the second channel 190. The missing or damaged data packets received in the first transmission at step 184 are then extracted 192 from the data received in the second transmission over second channel at step 190. The extracted packets are then assembled 194 with the data received at step 184 to form an error data stream. Transceiver 26 is reset back to the first channel 196 (so that more data may be received at step 184), and the repaired data from step 194 is played back 198 by the receiving intercom 10. In this manner, the sound quality of transmitted signals is improved by repairing or replacing data that would have been otherwise lost in transmission. It should be recognized that sound quality improvement process 174 may be implemented in any digital transmitting and receiving device having a digital transceiver and associated microcontroller where reduced power consumption is advantageous. For example, process 174 could be implemented in a wireless security access system, a digital walkie-talkie system, or even in a wireless headset for a cellular or conventional telephone.

What is claimed is:

1. A digital transmission and communication device, comprising:
a digital transceiver;
a microcontroller interconnected to said transceiver, wherein said microcontroller includes a timer for measuring a time period during which said microcontroller turns said transceiver off.

2. The device of claim 1, wherein said microcontroller is programmed to awaken said transceiver when said time period has expired.

3. The device of claim 2, wherein said microcontroller is programmed to check to determine whether said transceiver has received a transmission after said microcontroller awakens said transceiver.

4. The device of claim 3, wherein said microcontroller is programmed to determine whether said transmission includes an identification data string.

5. The device of claim 4, further including a codec interconnected to said microcontroller.

6. The device of claim 5, wherein said microcontroller is programmed to playback said transmission through said codec if said transmission includes said identification data string.

7. The device of claim 6, wherein said time period is 500 milliseconds.

8. The device of claim 7, wherein said microcontroller restarts said timer and deactivates said transceiver after playback of said transmission is completed.

9. A method of controlling a digital transmission and communication device including a microcontroller and a digital transceiver, comprising the steps of:
checking to determine whether said transceiver is sending or receiving transmissions;
deactivating said transceiver if said transceiver is not sending or receiving transmissions;
measuring a first time period;
periodically activating said transceiver at a first rate during said first time period and then checking to determine whether said transceiver has received a transmission;
measuring a second time period if said first time period has expired without said transceiver receiving a transmission;
deactivating said microcontroller and said transceiver during said second time period; and
periodically activating said microcontroller and said transceiver at a second rate during said second time period and then checking to determine whether said transceiver has received a transmission.

10. The method of claim 9, further comprising the steps of:
deactivating said microcontroller and said transceiver if said second time period has expired without said transceiver receiving a transmission periodically activating said microcontroller and said transceiver at a third rate and checking to determine whether said transceiver has received a transmission.

11. The device of claim 10, wherein said first time period is shorter than said second time period.

12. The method of claim 11, wherein the first rate is faster than the second rate.

13. The method of claim 12, wherein the second rate is faster than the third rate.

14. The method of claim 13, wherein the second rate more than once per second.

15. The method of claim 14, wherein the third rate is less than once per second.

16. The method of claim 12, wherein said first time period is one hour.

17. The method of claim 12, wherein said second time period is four hours.

18. A digital transmission and communication device, comprising:
a digital transceiver;
a microcontroller interconnected to said transceiver;
a sleep timer for measuring a first time period during which said transceiver is deactivated, a second time period during which said microcontroller and said transceiver are deactivated, and a third time period during which said microcontroller and said transceiver are deactivated; and
a wake timer for periodically awakening said transceiver during said first, second, and third time periods.

19. The device of claim 18, wherein said wake timer periodically awakens said transceiver at a different rate in said second time period than in said third time period.

20. The device of claim 19, wherein said wake timer awakens said transceiver more frequently during said second time period than said third time period.
